(19) United States
(12) Patent Application Publication
(10) Pub. No.: US 2007/0161366 A1
(43) Pub. Date: Jul. 12, 2007

(54) Mobile terminal, method and computer program product for playing active media sound during a call

(75) Inventors: Christian Kraft, Frederiksberg C (DK); Peter Dam Nielsen, Kgs. Lyngby (DK)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/327,108

(22) Filed: Jan. 6, 2006

(51) Int. Cl. H04L 12/58

(52) U.S. Cl. 455/412.1

(57) ABSTRACT

A mobile terminal for dynamically controlling delivery of active media during a call includes an output device and a processing element. The output device is capable of providing an audible output. The processing element is capable of delivering the active media to the output device of the mobile terminal while the call is on-going.

### FIELD OF THE INVENTION

Embodiments of the present invention relate generally to wireless technology and, more particularly, relate to enabling a mobile terminal to play active media sound during a call.

### BACKGROUND OF THE INVENTION

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to processing and delivery of active media to an output device of a mobile terminal. The active media may include radio broadcast data, music data, a television program, etc. Accordingly, technology has been developed to provide networks capable of delivering such active media to mobile terminals.

With the development of improved means for delivery of active media to mobile terminals, mobile terminals have become capable of providing multiple different services in addition to traditional mobile telephone wireless communication. However, it is currently common that a mobile terminal receiving a call must stop processing and delivering active media while the mobile terminal is engaged in telephone communication. Accordingly, important calls may be missed if a user of the mobile terminal does not wish to interrupt the active media. Alternatively, active media content may be lost if calls are accepted while receiving the active media. This is particularly true since pausing delivery of the active media is not feasible for certain programs, such as, for example, live broadcasts, sporting events, etc. Thus, a need exists for providing a user the ability to dynamically control reception and delivery of active media during a call.

### BRIEF SUMMARY OF THE INVENTION

A system, method, apparatus and computer program product are therefore provided which allows a user of a mobile terminal to dynamically control delivery of active media during a call. Accordingly, calls may not be missed and active media may be fully experienced without interruption.

According to an exemplary embodiment, a mobile terminal for dynamically controlling delivery of active media during a call is provided. The mobile terminal includes an output device and a processing element. The output device is capable of providing an audible output. The processing element is capable of delivering the active media to the output device of the mobile terminal while the call is on-going.

According to an exemplary embodiment, a method for dynamically controlling delivery of active media during a call is provided. The method includes operations of receiving active media, receiving call data, and delivering both the active media and call data to an output device of the mobile terminal simultaneously.

According to an exemplary embodiment, a computer program product for dynamically controlling delivery of active media during a call is provided. The computer program product includes a first executable portion, a second executable portion and a third executable portion. The first executable portion is for receiving active media. The second executable portion is for receiving call data. The third executable portion is for delivering both the active media and call data to an output device of the mobile terminal simultaneously.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a controller of a mobile terminal according to an exemplary embodiment of the present invention; and

FIG. 4 is a block diagram according to an exemplary method of dynamically controlling delivery of active media to an output device of a mobile terminal during a call.

### DETAILED DESCRIPTION OF THE INVENTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

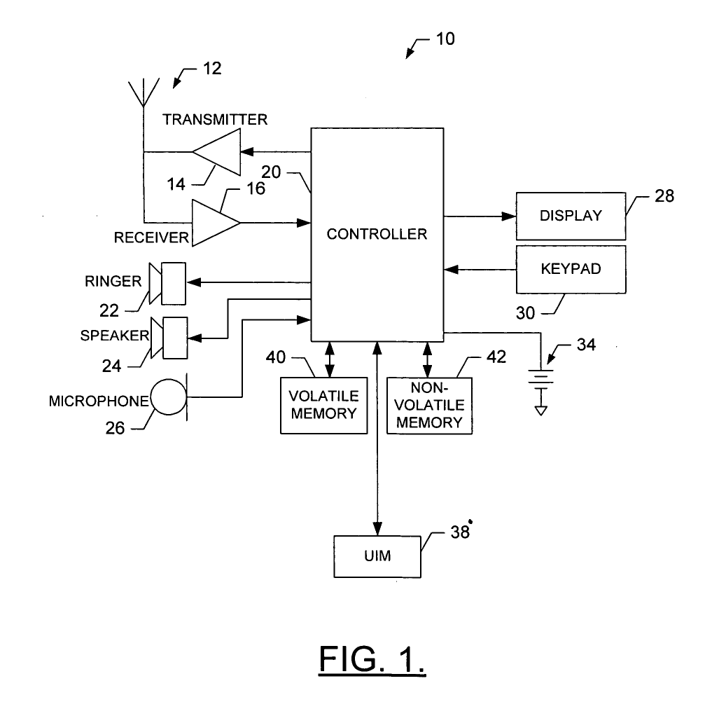

FIG. 1, describing one exemplary embodiment of the invention, illustrates a block diagram of a mobile terminal 10 that would benefit from the present invention. It should be understood, however, that a mobile telephone as illustrated and hereinafter described is merely illustrative of one type of mobile terminal that would benefit from the present invention and, therefore, should not be taken to limit the scope of the present invention. While several embodiments of the mobile terminal 10 are illustrated and will be hereinafter described for purposes of example, other types of mobile terminals or devices, such as portable digital assistants (PDAs), mobile communication devices, pagers, mobile television, laptop computers, audio devices, audio/video devices, digital cameras, digital camcorders and other types of voice and text communications systems, or any combination of the above mentioned devices, can readily employ the present invention.

In addition, while several embodiments of the method of the present invention are performed or used by a mobile terminal 10, the method may be employed by other than a mobile terminal. Moreover, the system and method of the present invention will be primarily described in conjunction with mobile communications applications. It should be understood, however, that the system and method of the present invention can be utilized in conjunction with a variety of other applications, both in the mobile communications industries and outside of the mobile communications industries.

The mobile terminal 10 includes an antenna 12 in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second and/or third-generation communication protocols or the like. For example, the mobile terminal 10 may be capable of operating in accordance with second-generation (2G) wireless communication protocols IS-136 (TDMA), GSM, and IS-95 (CDMA).

It is understood that the controller 20 includes circuitry required for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content, according to a Wireless Application Protocol (WAP), for example. Also, for example, the controller 20 may be capable of operating a software application capable of creating an authorization for delivery of location information regarding the mobile terminal 10, in accordance with embodiments of the present invention (described below).

The mobile terminal 10 also comprises a user interface including an output device such as a conventional earphone or speaker 22, a ringer 24, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 includes the conventional numeric (0-9) and related keys (#, *), and other keys used for operating the mobile terminal 10. The mobile terminal 10 further includes a battery 34, such as a vibrating battery pack, for powering various circuits that are required to operate the mobile terminal 10, as well as optionally providing mechanical vibration as a detectable output. The mobile terminal 10 may further include a universal identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

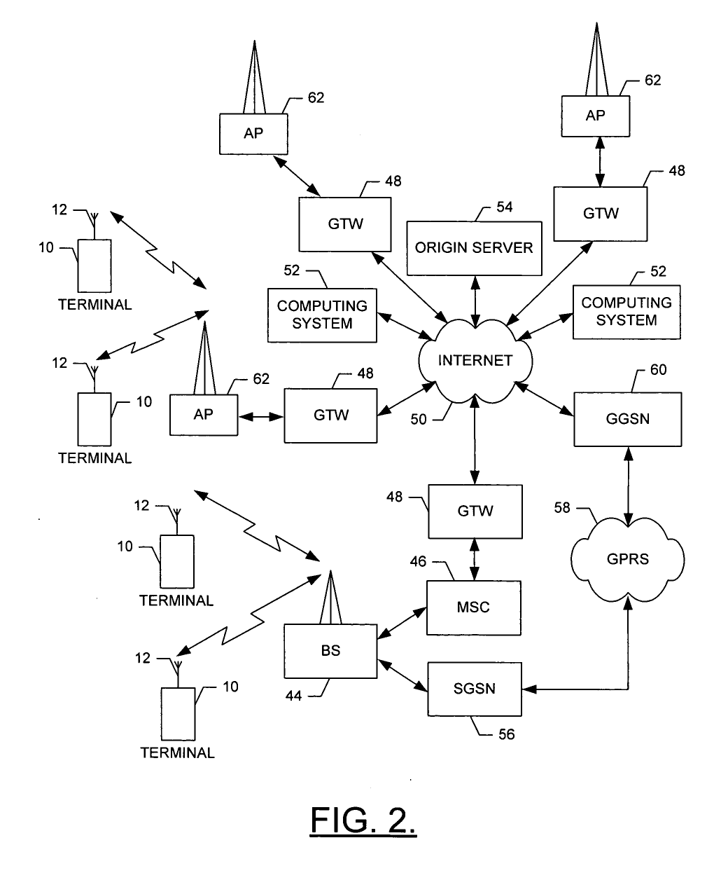

Referring now to FIG. 2, describing one exemplary embodiment of the invention, an illustration of one type of system that would benefit from the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and the present invention is not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a GTW 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP), to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), WiMAX techniques such as IEEE 802.16, and/or ultra wideband (UWB) techniques such as IEEE 802.15 or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX and/or UWB techniques. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including USB, LAN, WLAN, WiMAX and/or UWB techniques.

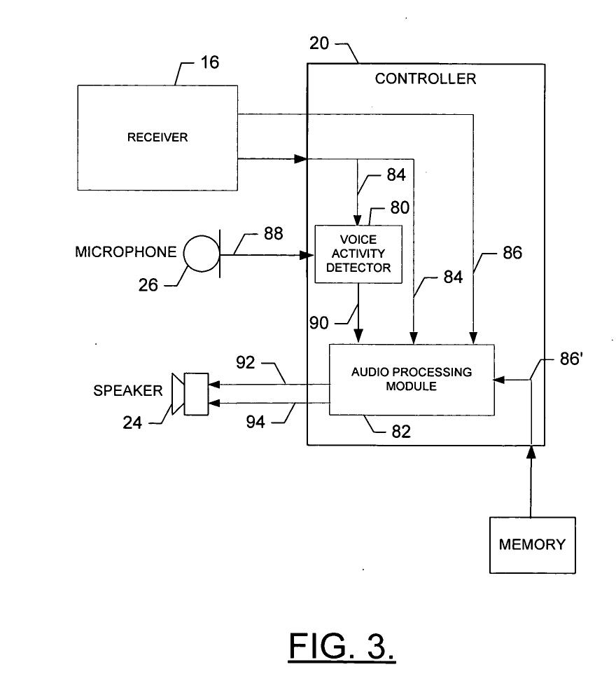

An exemplary embodiment of the invention will now be described with reference to FIG. 3, in which certain elements of the mobile terminal 10 of FIG. 1 are shown in greater detail. It should be noted, however, that while FIG. 3 illustrates merely one example of a configuration of a controller for a mobile terminal, numerous other configurations may also be used to implement the present invention. Referring now to FIG. 3, the controller 20 includes a voice activity detector (VAD) 80 and an audio processing module 82. In an exemplary embodiment, the VAD 80 and the processing module 82 are embodied in the form of software applications executed by the processor. As such, instructions for performing the functions of the VAD 80 and the processing module 82 may be stored in a memory (for example, either the volatile memory 40 or the non-volatile memory 42) of the mobile terminal 10 and executed by the controller 20.

The audio processing module 82 may be any device or means embodied in either hardware, software, or a combination of hardware and software that is capable of receiving multiple audio data inputs and delivering multiple audio data outputs responsive to a control signal. In an exemplary embodiment, the audio data inputs may include call data 84 and active media content 86. The call data is, for example, audio data that has been wirelessly transmitted from another mobile terminal to the mobile terminal 10. The active media 86 may include radio broadcast data, digital radio broadcast data (for example, digital audio broadcasting (DAB), digital radio mondiale (DRM)), music data, video data, a television broadcasted program, digital television broadcast data, such as DVB (S/T/C/H), DMB (S/T), etc. that is wirelessly received at the receiver 16 of the mobile terminal 10. The active media 86 may also be communicated to the controller 20 via the call data 84 substantially simultaneously. Additionally, previously received stored active media 86′ may be stored in the memory (either the volatile memory 40 or the non-volatile memory 42) of the mobile terminal 10 and communicated, for example, to the audio processing module 82 and, in turn, to the speaker 24 when directed by the controller 20. Accordingly, the stored active media 86′ may be communicated to the audio processing module from the memory prior to receiving a call or during an existing call.

The VAD 80 may be any device or means embodied in either hardware, software, or a combination of hardware and software that is capable of monitoring transmissions including call data and determining whether voice activity is present. For example, in response to receipt of a call, such as a wireless telephone call, the receiver 16 communicates the call data 84 to the controller 20. In the exemplary embodiment of FIG. 3, the call data 84 is communicated to the VAD 80. The call data 84 may be an IP call (for example, VoIP, Internet call, Skype, etc.) or a conference call. The call data 84 may include caller voice data which can be detected by the VAD 80. Additionally, user voice data input into the mobile terminal 10 by, for example, the microphone 26 may be communicated to the VAD 80 and detected. In response to detection of any voice data, the VAD 80 may indicate a presence of voice data to the audio processing module 82 via a message 90. Alternatively, the message 90 may be sent to the audio processing module 82 to indicate an absence of voice data. In other words, the message 90 sent from the VAD 80 is capable of signaling periods of silence and periods of voice activity during a call. Accordingly, during the course of the call, the message 90 informs the audio processing module 82 of alternating periods of silence and activity.

In an exemplary embodiment, the audio processing module 82 is capable of simultaneously delivering or communicating output active media 92 and output call data 94 to the speaker 24. Conventional mobile terminals typically include specific modes devoted to either outputting active media or outputting call data. In other words, it is currently common for a mobile telephone to include a call mode, in which call data is delivered as an audible output, and a media play mode, in which active media is delivered as an audible and/or visible output. However, the mobile terminal 10 according to an embodiment of the present invention is capable of simultaneous delivery of the output active media 92 and output call data 94 to an output device of the mobile terminal 10. In other words, the mobile terminal 10 according to an exemplary embodiment of the present invention is capable of delivering the output active media 92 during an on-going call.

In order to achieve the simultaneous delivery of the output active media 92 and output call data 94 to an output device of the mobile terminal 10 in an intelligible and useful manner, the controller 20 (and in one embodiment the audio processing module 82) processes the active media 86 (or stored active media 86′) and the call data 84 prior to delivery of the output active media 92 and output call data 94. In an exemplary embodiment, the controller 20 processes the active media 86 and the call data 84 responsive to the presence or absence of a period of silence in the call data 84. The period of silence may be indicated, as described above, by the message 90. For example, the controller 20 may deliver the output call data 94 continuously, while only communicating the output active media 92 in response to an indication of the period of silence. Accordingly, during periods of silence the output active media 92 is audible, but during periods of voice activity in the call data 84, only the output call data 94 is delivered to the output device. In an exemplary embodiment, the controller 20 may wait a predetermined period of time after sensing the period of silence before delivering the output active media 92 to the output device. Such a time delay may be used, for example, to ensure that the user is “on hold”. As an example, the controller 20 may only deliver the output active media 92 in response to at least three seconds of silence. Thus, the message 90 indicating the period of silence may be delayed accordingly by three seconds. Furthermore, in order to ensure that the output active media 92 is not delivered at a sudden loud volume, the controller 20 may gradually increase a volume of the output active media 92 from a low level to a normal level in response to the indication of the period of silence. Additionally, the controller may temporarily store active media 86 in the memory for delivery of the output active media 92 to the output device during silent periods. In this way, for example, live broadcast active media may be stored temporarily and delivered to the output device during silent periods to ensure the user does not miss portions of the live broadcast.

If the VAD 80 detects a period of silence and is operated such that the output active media 92 is only delivered to the output device during the period of silence, then, in an exemplary embodiment, the message 90 may indicate an end of the period of silence to the audio processing module 82. In response to the message 90 indicating the end of the period of silence, the output active media 92 may no longer be communicated to the output device. Alternatively, a volume of the output active media 92 may be modified as described below in response to the message 90 indicating the end of the period of silence.

In another exemplary embodiment, the controller 20 processes the active media 86 and the call data 84 such that the output active media 92 and the output call data 94 are delivered to the output device simultaneously, but at different volume levels. For example, the output call data 94 may be delivered at a full or normal volume, while the output active media 92 is concurrently delivered at a lower volume. Thus, the output active media 92 may sound like background music, background programming, etc. when heard through the speaker 24. Accordingly, it may be possible to continuously deliver the output active media 92 and the output call data 94 simultaneously in an intelligible manner. In an exemplary embodiment, the output active media 92 is delivered at a volume that is a predetermined fraction of the volume of the output call data 94. Accordingly, if the user of the mobile phone 10 chooses to alter the volume of the output call data 94, the volume of the output active media 92 will be adjusted accordingly.

In yet another exemplary embodiment, the controller 20 may deliver the output active media 92 at a normal volume during the period of silence, and at a reduced volume at other times. In this exemplary embodiment, the time delay and the gradual increase in volume described above may be employed to maximize a sound quality of the output active media 92. It should be noted that, although as described above, the speaker 24 may be driven by both the output call data 94 and output active media 92 simultaneously during silent periods, the audio processing module 82 may determine not to supply the output call data 94 during silent periods but re-supply the output call data 94 when conversation begins again.

A mode of operation of the mobile terminal 10 may be selected to enable simultaneously delivery of the output active media 92 and the output call data 94 as described in the embodiments above. Alternatively, the mobile terminal 10 may inherently be enabled to simultaneously deliver the output active media 92 and the output call data 94 as described in the embodiments above. In a case where the mobile terminal 10 includes a mode of operation enabling simultaneously delivery of the output active media 92 and the output call data 94, the mode of operation may be selected, for example, via a menu item on the mobile terminal 10. Furthermore, each of the features described above (i.e., the time delay, the gradual volume increase, continuous simultaneous delivery, delivery only during silent periods, etc.) may be user selectable via a menu or other user interface. Additionally, the mode of operation and the features described above may be selected at any time including during current calls or during currently received active media broadcasts.

It should be noted that simultaneous delivery of the output active media 92 and the output call data 94 may be initiated regardless of the order in which the active media 86 and the call data 84 are received. In other words, during a current call, the user may select to begin simultaneous delivery of the output active media 92 with the output call data 94. Alternatively, the user may select to begin simultaneous delivery of output call data 94 generated responsive to an incoming call with output active media 92 that was previously being delivered to the output device. Thus, for example, if the user was listening to music via a music player when a call is received, the user may select to play the music in the background during the call, play the music during silent periods of the call, etc. Alternatively, if the user was watching a television broadcast when an incoming call is received, the display may continue to show the video while the audio broadcast is played, for example, either in the background of the incoming call or during silent periods of the incoming call. As another alternative, the user may be listing to music and decide to simultaneously make or receive a call. It should also be noted that call data 84 may be received subsequent to a call initiated by the user of the mobile terminal 10.

It should also be noted that the active media 86 may be sent to the mobile terminal 10 by a caller. In other words, the caller may send the active media 86 to the mobile terminal 10 either before or during a call. Thus, for example, the user of the mobile terminal 10 may carry on a conversation with the active media 86 sent by the caller playing in the background. Such an embodiment may be useful for friends to share music and then get feedback regarding the music while the music is played in the background of the conversation. Furthermore, the output active media 92 may be delivered from the memory or another source in response to predefined criteria. For example, the controller 20 may automatically execute predetermined instructions selected by the user, which retrieve specific stored active media 86′ or active media 86 from a particular source in response to placing or receiving a call from a particular individual.

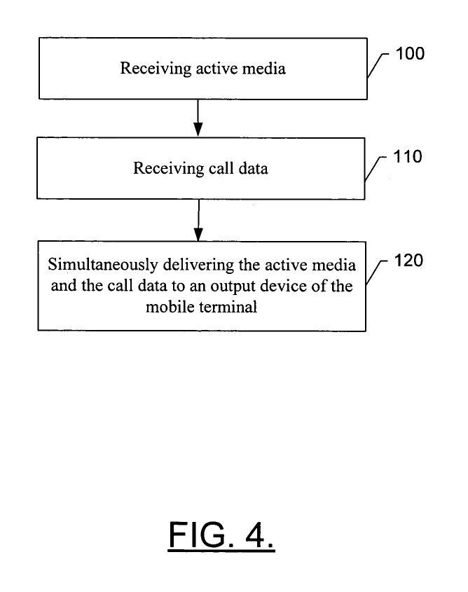

FIG. 4 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for dynamically controlling delivery of active media to an output device of a mobile terminal includes receiving active media at operation 100. The active media may be currently received active media, such as, for example, a live broadcast, or the active media may be previously received and currently stored active media. At operation 110, call data is received. It is important to recognize that operations 100 and 110 may occur in any order. In other words, for example, a call may be pre-existing in which call data is being received when active media is received, or previously received active media may be played when an incoming call is received. At operation 120, the active media and the call data are simultaneously delivered to an output device of the mobile terminal.

The above described functions may be carried out in many ways. For example, any suitable means for carrying out each of the functions described above may be employed to carry out the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A mobile terminal for dynamically controlling delivery of active media during a call, the mobile terminal comprising:
an output device capable of providing an audible output;
a processing element capable of delivering the active media to the output device of the mobile terminal while the call is on-going.

2. The mobile terminal of claim 1, wherein the processing element is configured to detect a period of silence during the call.

3. The mobile terminal of claim 2, wherein the processing element is configured to deliver the active media to the output device during the period of silence.

4. The mobile terminal of claim 3, wherein the processing element is configured to gradually increase a volume of the active media when beginning to deliver the active media during the period of silence.

5. The mobile terminal of claim 2, wherein the processing element is configured to store active media content received during the call and deliver the stored active media content during the period of silence.

6. The mobile terminal of claim 2, wherein the processing element is configured to deliver the active media at a first volume during the period of silence and a second volume during remaining periods.

7. The mobile terminal of claim 6, wherein the first volume is higher than the second volume.

8. The mobile terminal of claim 1, wherein during simultaneous delivery of both the active media and the call data, the processing element is further capable of delivering the active media at a first volume and the call data at a second volume.

9. The mobile terminal of claim 8, wherein the first volume is lower than the second volume.

10. The mobile terminal of claim 1, wherein the processing element is configured to provide a user selectable option which enables simultaneous delivery of both the active media and the call data to the output device, the user selectable option being capable of selection during one of an existing call and currently delivered active media content.

11. The mobile terminal of claim 1, wherein the processing element is configured to deliver active media that is automatically selected based on predetermined criteria.

12. The mobile terminal of claim 1, wherein the processing element is configured to deliver active media that is selected by a caller to the mobile terminal.

13. The mobile terminal of claim 12, wherein the processing element is configured to deliver active media that is transmitted to the mobile terminal by the caller.

14. The mobile terminal of claim 1, wherein the processing element is configured to deliver active media that is rendered prior to activation of the call.

15. A computer program product for dynamically controlling delivery of active media to a mobile terminal during a call, the computer program product comprising at least one computer-readable storage medium having computer-readable program code portions stored therein, the computer-readable program code portions comprising:
a first executable portion for receiving active media;
a second executable portion for receiving call data; and
a third executable portion for simultaneously delivering both the active media and call data to the output device.

16. The computer program product of claim 15, further comprising a fourth executable portion for detecting a period of silence in the call data.

17. The computer program product of claim 16, further comprising a fifth executable portion for changing a volume of the active media responsive to the detection of the period of silence.

18. The computer program product of claim 16, further comprising a fifth executable portion for starting delivery of the active media responsive to the detection of the period of silence and stopping delivery of the active media responsive to detection of an end of the period of silence.

19. The computer program product of claim 16, further comprising a fifth executable portion for storing active media content received during the call and delivering the stored active media content during the period of silence.

20. The computer program product of claim 15, wherein the third executable portion is further capable of delivering the active media at a first volume and delivering the call data at a second volume.

21. The computer program product of claim 20, wherein the third executable portion is further capable of delivering the active media at the first volume which is a pre-defined fraction of the second volume.

22. The computer program product of claim 15, further comprising a fourth executable portion for providing an option to enable simultaneous delivery of both the active media and call data.

23. The computer program product of claim 15, further comprising a fourth executable portion for delivering active media that is rendered prior to activation of the call.

24. A method for dynamically controlling delivery of active media to a mobile terminal during a call, the method comprising:
receiving active media;
receiving call data; and
delivering both the active media and call data to an output device of the mobile terminal simultaneously.

25. The method of claim 24, further comprising detecting a period of silence in the call data.

26. The method of claim 25, further comprising changing a volume of the active media responsive to the detection of the period of silence.

27. The method of claim 25, further comprising starting delivery of the active media responsive to the detection of the period of silence and stopping delivery of the active media responsive to detection of an end of the period of silence.

28. The method of claim 25, further comprising storing active media content received during the call and delivering the stored active media content during the period of silence.

29. The method of claim 24, further comprising delivering the active media at a first volume and delivering the call data at a second volume.

30. The method of claim 29, further comprising delivering the active media at the first volume which is a pre-defined fraction of the second volume.

31. The method of claim 24, further comprising providing a user selectable option to enable simultaneous delivery of both the active media and the call data wherein the user selectable option is capable of selection during one of an existing call and currently delivered active media content.

32. The method of claim 24, wherein receiving active media comprises receiving active media that was previously stored in a memory device of the mobile terminal.

33. The method of claim 24, further comprising delivering active media that is rendered prior to activation of the call.
